(19) United States
(12) Patent Application Publication
(10) Pub. No.: US 2012/0164395 A1
(43) Pub. Date: Jun. 28, 2012

(54) MANUFACTURING METHOD FOR PLASTIC MEMBER AND PLASTIC MEMBER

(75) Inventor: Toshiki Ito, Kawasaki-shi (JP)

(73) Assignee: CANON KABUSHIKI KAISHA, Tokyo (JP)

(21) Appl. No.: 13/377,741

(22) PCT Filed: Aug. 27, 2010
(86) PCT No.: PCT/JP2010/065080

§ 371 Date: Dec. 12, 2011

(30) Foreign Application Priority Data
Sep. 2, 2009 (JP) 2009-202936

(51) Int. Cl. B32B 3/10; B29D 11/00; G02B 1/12

(52) U.S. Cl. 428/189; 264/1.36

(57) ABSTRACT

A manufacturing method for a plastic member having composition distribution includes: charging a first radiation polymerizable composition containing a first monomer being radiation-polymerizable into a casting cell having formed thereon a radiation irradiation surface; obtaining a polymer of a first composition by irradiating the radiation irradiation surface of the casting cell with the radiation, to polymerize a part of the first radiation polymerizable composition; removing an unpolymerized part of the first radiation polymerizable composition from the casting cell; bringing into contact with the polymer of the first composition by charging a second radiation polymerizable composition containing a second monomer being radiation-polymerizable into gaps of the casting cell, which are generated by the removal; dispersing the second radiation polymerizable composition into the polymer of the first composition; and curing an entire of the second radiation polymerizable composition and the polymer of the first composition dispersed within the casting cell.

### TECHNICAL FIELD

The present invention relates to a manufacturing method for a plastic member having composition distribution and a plastic member.

### BACKGROUND ART

In various optical systems, such as an image formation system for a camera or an optical fiber, a pickup optical system for a copying machine or a compact disk, a plurality of lenses are required in order to correct various kinds of aberrations such as spherical aberration and chromatic aberration. In particular, in an imaging system or an optical system which is used under a white-color light source, in order to correct the chromatic aberration, increased numbers of lenses are required compared to a monochromatic optical system.

To this end, if there is used a radial type refractive index distributive lens having, in a lens medium, a refractive index gradient in a radial direction from an optical axis, an excellent effect particularly for the correction of the chromatic aberration may be exhibited. Therefore, the number of lenses for the chromatic aberration correction may be reduced, thereby being capable of realizing higher functions, such as down-sizing, wide-angle, and high-magnification of a zoom lens.

Refractive index distribution of a plastic lens can be formed through composition distribution in the medium, such as, for example, copolymerization ratio of two kinds or more of monomers having different refractive indices, or concentration distribution of inorganic fine particles having different refractive indices different from a matrix organic component.

For example, as a method of forming a composition distribution in the plastic lens, there is known one in which a solid polymer is brought into contact with a monomer solution, to thereby disperse the monomer within the polymer.

### CITATION LIST

### Patent Literature

PTL 1: Japanese Patent No. 03989035
PTL 2: Japanese Laid-open Patent Application No. H 07-40357

### SUMMARY OF INVENTION

### Technical Problem

The technology disclosed in PTL 1 is a method involving, after photo-curing a polymer until the polymer having self-shape holdability is obtained, swelling the polymer in a monomer to disperse the monomer. For that reason, a degree of curing of the polymer is high, and the dispersion of the monomer is delayed. As a result, it takes at least 17 days to disperse the monomer to a center portion of a sample having a diameter of 20 mm. An obtained difference of the refractive indices between the center portion and a peripheral portion is about 0.02.

The technology disclosed in PTL 2 requires a compression mechanism for a casting cell.

Besides, in order to obtain a large refractive index, it is effective to produce concentration distribution of fine particles such as metal oxides each having a large refractive index. However, PTL 1 and PTL 2 each do not disclose, in the method of manufacturing a plastic member having composition distribution through the dispersion of monomer, the method involving producing the concentration distribution using the fine particles.

The present invention has been made in view of the above-mentioned background arts, and provides a manufacturing method for a plastic member, which is capable of manufacturing the plastic member having composition distribution with a simple facility and a small number of steps for a short period of time.

The present invention also provides a plastic member having composition distribution, which is produced by the above-mentioned manufacturing method for a plastic member.

### Solution to Problem

In order to solve the above-mentioned problems, a manufacturing method for a plastic member having composition distribution includes the steps of: charging a first radiation polymerizable composition containing a first monomer being radiation-polymerizable into a casting cell having formed thereon a radiation irradiation surface; obtaining a polymer of a first composition by irradiating the radiation irradiation surface of the casting cell with the radiation, to thereby polymerize a part of the first radiation polymerizable composition; removing an unpolymerized part of the first radiation polymerizable composition from the casting cell; bringing into contact with the polymer of the first composition by charging a second radiation polymerizable composition containing a second monomer being radiation-polymerizable into gaps of the casting cell, which are generated by the removal; dispersing the second radiation polymerizable composition into the polymer of the first composition; and curing an entire of the second radiation polymerizable composition and the polymer of the first composition dispersed within the casting cell.

A plastic member to solve the above-mentioned problems is the plastic member, which is manufactured by the above-mentioned method of manufacturing a plastic member.

### ADVANTAGEOUS EFFECTS OF INVENTION

According to the present invention, it is possible to provide the method capable of manufacturing a plastic member having composition distribution with a simple facility and a small number of steps, and for a short period of time.

In addition, according to the present invention, it is possible to provide the plastic member having composition distribution, which is manufactured by the above-mentioned manufacturing method for a plastic member. Further, according to the present invention, the plastic member can be obtained having concentration distribution of the fine particles.

Further features of the present invention will become apparent from the following description of exemplary embodiments with reference to the attached drawings.

### BRIEF DESCRIPTION OF DRAWINGS

FIGS. 1A, 1B, 1C, 1D, 1E, 1F and 1G illustrate a lens manufacturing method according to a first embodiment of the present invention.

FIG. 2 shows refractive-index distribution of a plastic member obtained in an example of the present invention.

FIG. 3 shows distributions of zirconium oxide fine particles of the plastic members obtained in examples of the present invention.

FIG. 4 shows distributions of zirconium oxide fine particles of the plastic members obtained in examples of the present invention.

FIG. 5 shows distributions of fluorescent X-ray intensity derived from silicon oxide fine particles of the plastic members obtained in examples of the present invention.

FIG. 6 shows a transmittance profile of a gray scale mask used in the example of the present invention.

FIG. 7 shows refractive-index distributions of the plastic members obtained in examples of the present invention.

FIG. 8 shows distributions of zirconium oxide fine particles of the plastic members obtained in examples of the present invention.

FIG. 9 shows refractive-index distributions of the plastic members obtained in examples of the present invention.

FIGS. 10A, 10B, 10C, 10D, 10E, 10F and 10G are process charts illustrating a manufacturing method for plastic members according to Comparative Examples 1 and 2.

FIGS. 11A, 11B and 11C show refractive-index distributions of a plastic member obtained in Example 8 of the present invention, in which: FIG. 11A shows Example 8-2; FIG. 11B shows Example 8-3; and FIG. 11C shows Example 8-4.

FIG. 12 is a graph showing a relationship between an exposure time period of irradiated ultraviolet rays and a complex viscosity of a polymer of a first composition of Example 8 of the present invention.

FIGS. 13A and 13B illustrate a lens manufacturing method according to a second embodiment of the present invention.

### DESCRIPTION OF THE EMBODIMENTS

Hereinafter, Embodiments of the present invention are described in detail.

### First Embodiment

A manufacturing method for a plastic member having composition distribution, according to this embodiment, includes the steps of: charging a first radiation polymerizable composition containing a first monomer being radiation-polymerizable into a casting cell having formed thereon a radiation irradiation surface; obtaining a polymer of a first composition by irradiating the radiation irradiation surface of the casting cell with the radiation, to thereby polymerize a part of the first radiation polymerizable composition; removing an unpolymerized part of the first radiation polymerizable composition from the casting cell; bringing into contact with the polymer of the first composition by charging a second radiation polymerizable composition containing a second monomer being radiation-polymerizable into gaps of the casting cell, which are generated by the removal; dispersing the second radiation polymerizable composition into the polymer of the first composition; and curing an entire of the second radiation polymerizable composition and the polymer of the first composition dispersed within the casting cell.

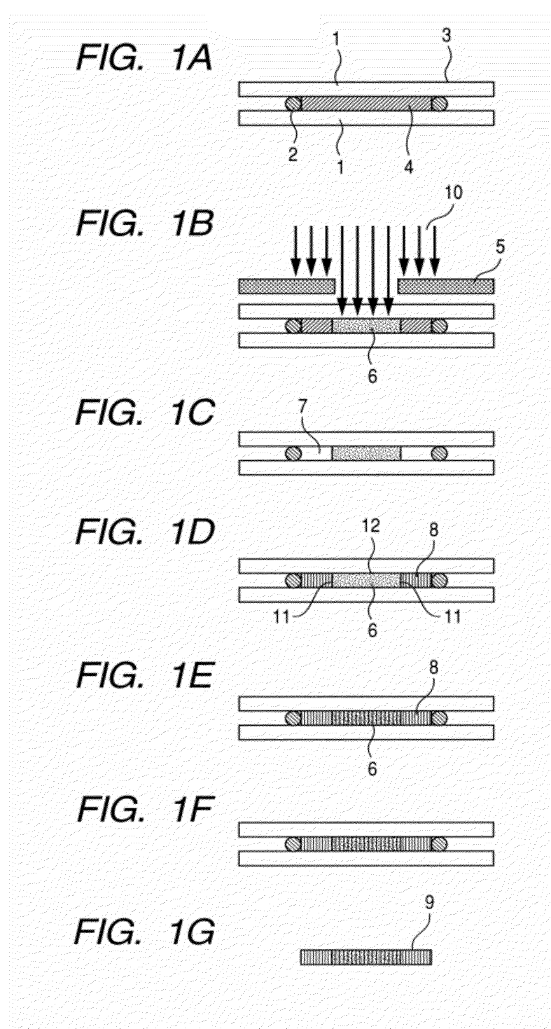

Description is made of a manufacturing method for a plastic member according to this embodiment with reference to drawings. FIGS. 1A to 1G are process charts illustrating one aspect of the manufacturing method for a plastic member according to the present invention.

A casting cell 3 is prepared, including gaskets 2 provided between a pair of optical glasses 1. Between the gaskets of the casting cell 3 having formed thereon a light irradiation surface formed of the optical glass 1, the first radiation polymerizable composition 4 containing the first monomer being radiation-polymerizable is charged (FIG. 1A).

By irradiating a part of the light irradiation surface, which is formed by providing a shield 5 above the casting cell, with a radiation 10, such as light, a part of the first radiation polymerizable composition 4 within the casting cell is polymerized, to thereby obtain a polymer 6 of the first composition (FIG. 1B).

An unpolymerized first radiation polymerizable composition is removed from the casting cell (FIG. 1C).

A second radiation polymerizable composition 8 containing a second monomer being radiation-polymerizable is charged into gaps 7 of the casting cell generated by the removal, thereby being brought into contact with the polymer 6 of the first composition (FIG. 1D).

After leaving stand for a predetermined period of time, the second radiation polymerizable composition is dispersed within the polymer of the first composition (FIG. 1E).

An entire of the second radiation polymerizable composition and the polymer of the first composition dispersed within the casting cell is cured through radiation irradiation or heating (FIG. 1F).

A cured product is taken out from the casting cell, thereby obtaining a plastic member 9 having composition distribution (FIG. 1G).

Hereinafter, description is made of a material used in the manufacturing method according to this embodiment.

(First Radiation Polymerizable Composition) A first radiation polymerizable composition (A) includes a radiation-sensitive polymerization initiator (c), and a first monomer (d) being radiation-polymerizable. Further, the first radiation polymerizable composition may contain fine particles (e), a photosensitizer (f), and a thermal polymerization initiator (g).

As the first monomer (d), there is exemplified a radical polymerizable monomer or a cation polymerizable monomer.

As the radical polymerizable monomer, a compound having one or more acryloyl groups or methacryloyl groups is preferred.

As the cation polymerizable monomer, a compound having one or more vinyl ether groups, epoxy groups, or oxetanyl groups is preferred.

As monofunctional (meth)acrylic compounds having one acryloyl group or methacryloyl group, there are exemplified, for example, phenoxyethyl(meth)acrylate, phenoxy-2-methylethyl(meth)acrylate, phenoxyethoxyethyl(meth)acrylate, 3-phenoxy-2-hydroxypropyl(meth)acrylate, 2-phenylphenoxyethyl (meth)acrylate, 4-phenylphenoxyethyl(meth)acrylate, 3-(2-phenylphenyl)-2-hydroxypropyl(meth)acrylate, a (meth)acrylate of p-cumylphenol reacted with ethylene oxide, 2-bromophenoxyethyl(meth)acrylate, 2,4-dibromophenoxyethyl(meth)acrylate, 2,4,6-tribromophenoxyethyl(meth)acrylate, phenoxy (meth)acrylate modified with multiple moles of ethylene oxide or propylene oxide, polyoxyethylene nonylphenyl ether(meth)acrylate, isobornyl(meth)acrylate, bornyl (meth)acrylate, tricyclodecanyl(meth)acrylate, dicyclopentanyl(meth)acrylate, dicyclopentenyl (meth)acrylate, cyclohexyl(meth)acrylate, 4-butylcyclohexyl(meth)acrylate, acryloyl morpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, benzyl(meth)acrylate, tetrahydrofurfuryl(meth)acrylate, butoxyethyl(meth)acrylate, ethoxy diethylene glycol(meth)acrylate, polyethylene glycol mono(meth)acrylate, polypropylene glycol mono(meth)acrylate, methoxy ethylene glycol(meth)acrylate, ethoxyethyl(meth)acrylate, methoxy polyethylene glycol(meth)acrylate, methoxy polypropylene glycol(meth)acrylate, diacetone(meth)acrylamide, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, 7-amino-3,7-dimethyloctyl(meth)acrylate, N,N-diethyl(meth)acrylamide, N,N-dimethylaminopropyl(meth)acrylamide, and the like, but are not limited thereto.

As commercially available monofunctional (meth)acrylic compounds, there are exemplified, for example, Aronix M101, M102, M110, M111, M113, M117, M5700, TO-1317, M120, M150, and M156 (all of the above are manufactured by TOAGOSEI CO., LTD); LA, IBXA, 2-MTA, HPA, and Viscoat #150, #155, #158, #190, #192, #193, #220, #2000, #2100, and #2150 (all of the above are manufactured by OSAKA ORGANIC CHEMICAL INDUSTRY LTD.); Light Acrylate BO-A, EC-A, DMP-A, THF-A, HOP-A, HOA-MPE, HOA-MPL, PO-A, P-200A, NP-4EA, and NP-8EA, and Epoxy Ester M-600A (all of the above are manufactured by KYOEISHA CHEMICAL Co., LTD); KAYARAD TC110S, R-564, and R-128H (all of the above are manufactured by NIPPON KAYAKU Co., Ltd.); NK Ester AMP-10G and AMP-20G (both of the above are manufactured by Shin-Nakamura Chemical Co., Ltd.); FA-511A, 512A, and 513A (all of the above are manufactured by Hitachi Chemical Co., Ltd.); PHE, CEA, PHE-2, PHE-4, BR-31, BR-31M, and BR-32 (all of the above are manufactured by Dai-ichi Kogyo Seiyaku Co., Ltd.); VP (manufactured by BASF); ACMO, DMAA, and DMAPAA (all of the above are manufactured by KOHJIN Co., Ltd.), and the like, but are not limited thereto.

As polyfunctional (meth)acrylic compounds having two or more acryloyl groups or methacryloyl groups, there are exemplified, for example, trimethylolpropane di(meth)acrylate, trimethylolpropane tri(meth)acrylate, EO-modified trimethylolpropane tri(meth)acrylate, PO-modified trimethylolpropane tri(meth)acrylate, EO,PO-modified trimethylolpropane tri(meth)acrylate, pentaerythritol tri(meth)acrylate, pentaerythritol tetra(meth)acrylate, ethylene glycol di(meth)acrylate, tetraethylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, tris(2-hydroxyethyl)isocyanurate tri(meth)acrylate, tris(acryloyloxy)isocyanurate(meth)acrylate, bis(hydroxymethyl)tricyclodecane di(meth)acrylate, dipentaerythritol penta(meth)acrylate, dipentaerythritol hexa(meth)acrylate, EO-modified 2,2-bis(4-((meth)acryloxy)phenyl)propane, PO-modified 2,2-bis(4-((meth)acryloxy)phenyl)propane, EO,PO-modified 2,2-bis(4-((meth)acryloxy)phenyl)propane, and the like, but are not limited thereto.

Any one of those compounds may be used alone, or two or more kinds of the compounds may be used in combination. It should be noted that, in the foregoing description, “(meth)acrylate” means an acrylate and the corresponding methacrylate, “(meth)acryloyl group” means an acryloyl group and the corresponding methacryloyl group, “EO” represents ethylene oxide, and an EO-modified compound has a block structure of an ethylene oxide group. In addition, “PO” represents propylene oxide, and a PO-modified compound has a block structure of a propylene oxide group.

As commercially available polyfunctional (meth)acrylic compounds, there are exemplified, for example, Upimer UV SA1002 and SA2007 (both of the above are manufactured by Mitsubishi Chemical Corporation); Viscoat #195, #230, #215, #260, #335HP, #295, #300, #360, #700, GPT, and 3PA (all of the above are manufactured by OSAKA ORGANIC CHEMICAL INDUSTRY LTD.); Light Acrylate 4EG-A, 9EG-A, NP-A, DCP-A, BP-4EA, BP-4PA, TMP-A, PE-3A, PE-4A, and DPE-6A (all of the above are manufactured by KYOEISHA CHEMICAL Co., LTD); KAYARAD PET-30, TMPTA, R-604, DPHA, DPCA-20, -30, -60, -120, HX-620, D-310, and D-330 (all of the above are manufactured by NIPPON KAYAKU Co., Ltd.); Aronix M208, M210, M215, M220, M240, M305, M309, M310, M315, M325, and M400 (all of the above are manufactured by TOAGOSEI CO., LTD); Lipoxy VR-77, VR-60, and VR-90 (all of the above are manufactured by SHOWA HIGHPOLYMER CO., LTD.), and the like, but are not limited thereto.

As compounds having one vinyl ether group, there are exemplified, for example, methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxy polyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, phenoxy polyethylene glycol vinyl ether, and the like, but are not limited thereto.

As compounds having two or more vinyl ether groups, there are exemplified, for example, divinylethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, a propylene oxide adduct of dipentaerythritol hexavinyl ether, and the like, but are not limited thereto.

As compounds having one epoxy group, there are exemplified, for example, phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, 3-vinylcyclohexene oxide, and the like, but are not limited thereto.

As compounds having two or more epoxy groups, there are exemplified, for example, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, an epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl-5,5-spiro-3,4-epoxy)cyclohexane-metha-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylene bis(3,4-epoxycyclohexane), dicyclopentadiene diepoxide, a di(3,4-epoxycyclohexylmethyl)ether of ethylene glycol, ethylene bis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, 1,2,5,6-diepoxycyclooctane, and the like, but are not limited thereto.

As compounds having one oxetanyl group, there are exemplified, for example, 3-ethyl-3-hydroxymethyloxetane, 3-(meth)allyloxymethyl-3-ethyloxetane, (3-ethyl-3-oxetanylmethoxy)methylbenzene, 4-fluoro[1-(3-ethyl-3-oxetanylmethoxy)methyl]benzene, 4-methoxy[1-(3-ethyl-3-oxetanylmethoxy)methyl]benzene, [1-(3-ethyl-3-oxetanylmethoxy)ethyl]phenyl ether, isobutoxymethyl (3-ethyl-3-oxetanylmethyl)ether, isobornyloxyethyl (3-ethyl-3-oxetanylmethyl)ether, isobornyl (3-ethyl-3-oxetanylmethyl)ether, 2-ethylhexyl (3-ethyl-3-oxetanylmethyl)ether, ethyldiethylene glycol (3-ethyl-3-oxetanylmethyl)ether, dicyclopentadiene (3-ethyl-3-oxetanylmethyl)ether, dicyclopentenyloxyethyl (3-ethyl-3-oxetanylmethyl)ether, dicyclopentenyl (3-ethyl-3-oxetanylmethyl)ether, tetrahydrofurfuryl (3-ethyl-3-oxetanylmethyl)ether, tetrabromophenyl (3-ethyl-3-oxetanylmethyl)ether, 2-tetrabromophenoxyethyl (3-ethyl-3-oxetanylmethyl)ether, tribromophenyl (3-ethyl-3-oxetanylmethyl)ether, 2-tribromophenoxyethyl (3-ethyl-3-oxetanylmethyl)ether, 2-hydroxyethyl (3-ethyl-3-oxetanylmethyl)ether, 2-hydroxypropyl (3-ethyl-3-oxetanylmethyl)ether, butoxyethyl (3-ethyl-3-oxetanylmethyl)ether, pentachlorophenyl (3-ethyl-3-oxetanylmethyl)ether, pentabromophenyl (3-ethyl-3-oxetanylmethyl)ether, bornyl (3-ethyl-3-oxetanylmethyl)ether, and the like, but are not limited thereto.

As compounds having two or more oxetanyl groups, there are exemplified, for example, polyfunctional oxetanes such as 3,7-bis(3-oxetanyl)-5-oxa-nonane, 3,3′-(1,3-(2-methylenyl)propanediyl bis(oxymethylene)) bis(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyl dimethylene (3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified bisphenol A bis(3-ethyl-3-oxetanylmethyl)ether, PO-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, EO-modified bisphenol F (3-ethyl-3-oxetanylmethyl)ether, and the like, but are not limited thereto.

It should be noted that, as the first monomer (d) component, a monofunctional monomer and a polyfunctional monomer preferably be used in combination.

The radiation-sensitive polymerization initiator (c) is a radiation-sensitive radical generating agent in a case where the first monomer (d) component is a radical polymerizable monomer, and in a case where the first monomer (d) component is a cation polymerizable monomer, the radiation-sensitive polymerization initiator (c) is a radiation-sensitive acid generating agent.

The radiation-sensitive radical generating agent is a compound, which causes a chemical reaction, generates a radical, and is capable of initiating radical polymerization through the irradiation of radiation, such as charged particle rays including as infrared rays, visible rays, ultraviolet rays, far ultraviolet rays, X rays, electron rays, and the like.

As such compounds, there are exemplified, for example, 2,4,5-triarylimidazole dimers which may be substituted such as a 2-(o-chlorophenyl)-4,5-diphenylimidazole dimer, a 2-(o-chlorophenyl)-4,5-di(methoxyphenyl)imidazole dimer, a 2-(o-fluorophenyl)-4,5-diphenylimidazole dimer, and a 2-(o- or p-methoxyphenyl)-4,5-diphenylimidazole dimer; benzophenone derivatives such as benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 4-chlorobenzophenone, 4,4′-dimethoxybenzophenone, and 4,4′-diaminobenzophenone; aromatic ketone derivatives such as 2-benzyl-2-dimethylamino-1-(4-morpholinophenyl)-butanone-1,2-methyl-1-[4-(methylthio)phenyl]-2-morpholino-propanone-1-one; quinones such as 2-ethylanthraquinone, phenanthrenequinone, 2-t-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone, and 2,3-dimethylanthraquinone; benzoin ether derivatives such as benzoin methyl ether, benzoin ethyl ether, and benzoin phenyl ether; benzoin derivatives such as benzoin, methylbenzoin, ethylbenzoin, and propylbenzoin; benzyl derivatives such as benzyl dimethyl ketal; acrydine derivatives such as 9-phenylacrydine, and 1,7-bis(9,9′-acrydinyl)heptane; N-phenylglycine derivatives such as N-phenylglycine; acetophenone derivatives such as acetophenone, 3-methylacetophenone, acetophenone benzyl ketal, 1-hydroxycyclohexyl phenyl ketone, and 2,2-dimethoxy-2-phenylacetophenone; thioxanthone derivatives such as thioxanthone, diethylthioxanthone, 2-isopropyl thioxanthone, and 2-chloro thioxanthone; and xanthone, fluorenone, benzaldehyde, fluorene, anthraquinone, triphenylamine, carbazole, 1-(4-isopropylphenyl)-2-hydroxy-2-methylpropan-1-one, 2-hydroxy-2-methyl-1-phenylpropan-1-one, 2,4,6-trimethylbenzoyldiphenylphosphine oxide, bis(2,6-dimethoxybenzoyl)-2,4,4-trimethylpentylphosphine oxide, and the like, but are not limited thereto. Any one of those compounds may be used alone, or two or more kinds of the compounds may be used in combination.

As commercially available radiation-sensitive radical generating agents, there are exemplified, for example, Irgacures 184, 369, 651, 500, 819, 907, 784, and 2959, CGI-1700, -1750, and -1850, CG24-61, and Darocur 1116 and 1173 (all of the above are manufactured by Ciba Japan K.K.), Lucirin TP0, LR8893, and LR8970 (all of the above are manufactured by BASF), Ubecryl P36 (manufactured by UCB), and the like, but are not limited thereto.

The radiation-sensitive acid generating agent is a compound, which causes a chemical reaction, generates an acid, and is capable of initiating cation polymerization through the irradiation of radiation, such as charged particle rays including as infrared rays, visible rays, ultraviolet rays, far ultraviolet rays, X rays, electron rays, and the like. As such compounds, there are exemplified, for example, an onium salt compound, a sulfonic acid ester compound, a sulfonimide compound, a diazomethane compound, and the like, but is not limited thereto. In this embodiment, it is preferred to use the onium salt compound.

As onium salt compounds, there are exemplified, for example, an iodonium salt, a sulfonium salt, a phosphonium salt, a diazonium salt, an ammonium salt, and a pyridinium salt. Specific examples of the onium salt compound include bis(4-t-butylphenyl)iodonium perfluoro-n-butanesulfonate, bis(4-t-butylphenyl)iodonium trifluoromethanesulfonate, bis(4-t-butylphenyl)iodonium 2-trifluoromethylbenzenesulfonate, bis(4-t-butylphenyl)iodonium pyrenesulfonate, bis(4-t-butylphenyl)iodonium n-dodecylbenzenesulfonate, bis(4-t-butylphenyl)iodonium p-toluenesulfonate, bis(4-t-butylphenyl)iodonium benzenesulfonate, bis(4-t-butylphenyl)iodonium 10-camphorsulfonate, bis(4-t-butylphenyl)iodonium n-octanesulfonate, diphenyliodonium perfluoro-n-butanesulfonate, diphenyliodonium trifluoromethanesulfonate, diphenyliodonium 2-trifluoromethylbenzenesulfonate, diphenyliodonium pyrenesulfonate, diphenyliodonium n-dodecylbenzenesulfonate, diphenyliodonium p-toluenesulfonate, diphenyliodonium benzenesulfonate, diphenyliodonium 10-camphorsulfonate, diphenyliodonium n-octanesulfonate, triphenylsulfonium perfluoro-n-butanesulfonate, triphenylsulfonium trifluoromethanesulfonate, triphenylsulfonium 2-trifluoromethylbenzenesulfonate, triphenylsulfonium pyrenesulfonate, triphenylsulfonium n-dodecylbenzenesulfonate, triphenylsulfonium p-toluenesulfonate, triphenylsulfonium benzenesulfonate, triphenylsulfonium 10-camphorsulfonate, triphenylsulfonium n-octanesulfonate, diphenyl(4-t-butylphenyl)sulfonium perfluoro-n-butanesulfonate, diphenyl(4-t-butylphenyl)sulfonium trifluoromethanesulfonate, diphenyl(4-t-butylphenyl)sulfonium 2-trifluoromethylbenzenesulfonate, diphenyl(4-t-butylphenyl)sulfonium pyrenesulfonate, diphenyl(4-t-butylphenyl)sulfonium n-dodecylbenzenesulfonate, diphenyl(4-t-butylphenyl)sulfonium p-toluenesulfonate, diphenyl(4-t-butylphenyl)sulfonium benzenesulfonate, diphenyl(4-t-butylphenyl)sulfonium 10-camphorsulfonate, diphenyl(4-t-butylphenyl)sulfonium n-octanesulfonate, tris(4-methoxyphenyl)sulfonium perfluoro-n-butanesulfonate, tris(4-methoxyphenyl)sulfonium trifluoromethanesulfonate, tris(4-methoxyphenyl)sulfonium 2-trifluoromethylbenzenesulfonate, tris(4-methoxyphenyl)sulfonium pyrenesulfonate, tris(4-methoxyphenyl)sulfonium n-dodecylbenzenesulfonate, tris(4-methoxyphenyl)sulfonium p-toluenesulfonate, tris(4-methoxyphenyl)sulfonium benzenesulfonate, tris(4-methoxyphenyl)sulfonium 10-camphorsulfonate, and tris(4-methoxyphenyl)sulfonium n-octanesulfonate, but are not limited thereto.

As sulfone compounds, there are exemplified, for example, β-ketosulfone, β-sulfonylsulfone, and α-diazo compounds thereof. Specific examples of the sulfone compound include, but are not limited to, phenacyl phenyl sulfone, mesithyl phenacyl sulfone, bis(phenylsulfonyl)methane, and 4-trisphenacyl sulfone, but are not limited thereto.

As sulfonic acid ester compounds, there are exemplified, for example, an alkyl sulfonic acid ester, a haloalky sulfonic acid ester, an allyl sulfonic acid ester, and an iminosulfonate. Specific examples of the sulfonic acid ester compound include, but are not limited to, α-methylolbenzoin perfluoro-n-butanesulfonate, α-methylolbenzoin trifluoromethanesulfonate, and α-methylolbenzoin 2-trifluoromethylbenzenesulfonate, but are not limited thereto.

As specific examples of the sulfonimide compounds, there are exemplified, for example, N-(trifluoromethylsulfonyloxy)succinimide, N-(trifluoromethylsulfonyloxy)phthalimide, N-(trifluoromethylsulfonyloxy)diphenylmaleimide, N-(trifluoromethylsulfonyloxy)bicyclo[2.2.1]hept-5-ene-2,3-dicarboximide, N-(trifluoromethylsulfonyloxy)-7-oxabicyclo[2.2.1]hept-5-ene-2,3-dicarboximide, N-(trifluoromethylsulfonyloxy)bicyclo[2.2.1]heptan-5,6-oxy-2,3-dicarboximide, N-(trifluoromethylsulfonyloxy)naphthylimide, N-(10-camphorsulfonyloxy)succinimide, N-(10-camphorsulfonyloxy)phthalimide, N-(10-camphorsulfonyloxy)diphenylmaleimide, N-(10-camphorsulfonyloxy)bicyclo[2.2.1]hept-5-ene-2,3-dicarboximide, N-(10-camphorsulfonyloxy)-7-oxabicyclo[2.2.1]hept-5-ene-2,3-dicarboximide, N-(10-camphorsulfonyloxy)bicyclo[2.2.1]heptan-5,6-oxy-2,3-dicarboximide, N-(10-camphorsulfonyloxy)naphthylimide, N-(4-methylphenylsulfonyloxy)succinimide, N-(4-methylphenylsulfonyloxy)phthalimide, N-(4-methylphenylsulfonyloxy)diphenylmaleimide, N-(4-methylphenylsulfonyloxy)bicyclo[2.2.1]hept-5-ene-2,3-dicarboximide, N-(4-methylphenylsulfonyloxy)-7-oxabicyclo[2.2.1]hept-5-ene-2,3-dicarboximide, N-(4-methylphenylsulfonyloxy)bicyclo[2.2.1]heptan-5,6-oxy-2,3-dicarboximide, N-(4-methylphenylsulfonyloxy)naphthylimide, N-(2-trifluoromethylphenylsulfonyloxy)succinimide, N-(2-trifluoromethylphenylsulfonyloxy)phthalimide, N-(2-trifluoromethylphenylsulfonyloxy)diphenylmaleimide, N-(2-trifluoromethylphenylsulfonyloxy)bicyclo[2.2.1]hept-5-ene-2,3-dicarboximide, N-(2-trifluoromethylphenylsulfonyloxy)-7-oxabicyclo[2.2.1]hept-5-ene-2,3-dicarboximide, N-(2-trifluoromethylphenylsulfonyloxy)bicyclo[2.2.1]heptan-5,6-oxy-2,3-dicarboximide, N-(2-trifluoromethylphenylsulfonyloxy)naphthylimide, N-(4-fluorophenylsulfonyloxy)succinimide, N-(4-fluorophenyl)phthalimide, N-(4-fluorophenylsulfonyloxy)diphenylmaleimide, N-(4-fluorophenylsulfonyloxy)bicyclo[2.2.1]hept-5-ene-2,3-dicarboximide, N-(4-fluorophenylsulfonyloxy)-7-oxabicyclo[2.2.1]hept-5-ene-2,3-dicarboximide, N-(4-fluorophenylsulfonyloxy)bicyclo[2.2.1]heptan-5,6-oxy-2,3-dicarboximide, and N-(4-fluorophenylsulfonyloxy)naphthylimide, but are not limited thereto.

As specific examples of the diazomethane compound, there are exemplified, for example, bis(trifluoromethylsulfonyl)diazomethane, bis(cyclohexylsulfonyl)diazomethane, bis(phenylsulfonyl)diazomethane, bis(p-toluenesulfonyl)diazomethane, methylsulfonyl p-toluenesulfonyldiazomethane, (cyclohexylsulfonyl)(1,1-dimethylethylsulfonyl)diazomethane, and bis(1,1-dimethylethylsulfonyl)diazomethane, but are not limited thereto.

Of the radiation-sensitive acid generating agents, the onium salt compound is preferred. In this embodiment, the acid generating agent may be used alone or a mixture of two or kinds.

A compounding ratio of the radiation-sensitive polymerization initiator (c) component is 0.01 mass % or more and 10 mass % or less, preferably 0.1 mass % or more and 3 mass % or less with respect to a total amount of the first radiation polymerizable composition (A) of this embodiment. If the compounding ratio is less than 0.01 mass %, its curing rate is lowered, thereby leading to a lower reaction efficiency. On the other hand, if the compounding ratio exceeds 10 mass %, the radiation-sensitive polymerizable composition may be inferior in points of curing property and handling property, and mechanical property and optical property of a cured product.

In the first radiation polymerizable composition (A) of this embodiment, the photosensitizer (f) may be added. Through the addition of the photosensitizer, it becomes possible to form composition distribution with a lesser amount of exposure. In this case, the photosensitizer is a compound, which is excited through the absorption of light having a specific wavelength, and has an interaction with the radiation-sensitive polymerization initiator (c) component. Coumarin derivatives, benzophenone derivatives, thioxanthone derivatives, anthracene derivatives, carbazole derivatives, perylene derivatives, and the like are exemplified, but are not limited thereto. The interaction referred here includes an energy movement or an electron movement from the photosensitizer in an excited state. Molar extinction coefficients of the photosensitizer (f) component with respect to exposure wavelengths are preferably larger than the molar extinction coefficients of the radiation-sensitive polymerization initiator (c) component.

(Second Radiation Polymerizable Composition)

For the second radiation polymerizable composition (B), the second radiation polymerizable composition (C) containing the second monomer (dl) being radiation-polymerizable is used.

As the second radiation polymerizable composition (C), the composition similar to the above-mentioned first radiation polymerizable composition (A) is used. In this case, there is used a composition, which differs in monomer and composition from the second radiation polymerizable composition (C) and the first radiation polymerizable composition (A), and differs in physical properties such as an optical property and electrical properties after being cured.

At least one of the first radiation polymerizable composition and the second radiation polymerizable composition of this embodiment can contain fine particles (e). The material constituting the fine particles (e) used in this embodiment is not particularly limited as long as being transparent with respect to the irradiation light described later, and as long as being uniformly dispersible within a radiation-sensitive polymerizable composition, organic materials, inorganic materials, or organic-inorganic materials can be used. The surface thereof may be modified.

As materials for forming the fine particle (e), there are exemplified, for example, titanium oxide (TiO₂), titanium hydroxide, zirconium oxide (ZrO₂), tantalum oxide (Ta₂O₅), aluminum oxide (Al₂O₃), niobium oxide (Nb₂O₅), tin oxide (SnO₂), antimony oxide (Sb₂O₅), zinc oxide (ZnO), silicon oxide (SiO₂), indium tin oxide (ITO), indium oxide (In₂O₃), lanthanum oxide (La₂O₃), gadolinium oxide (Gd₂O₃), hafnium oxide (HfO₂), erbium oxide (Er₂O₃), neodymium oxide (Nd₂O₃), cerium oxide (CeO₂), dysprosium oxide (Dy₂O₃), magnesium oxide (MgO), iron oxide (Fe₂O₃), iron hydroxide (Fe(OH)₃), gallium oxide (Ga₂O₃), gallium hydroxide (Ga(OH)₃), and an oxide mixture thereof, a hydroxide mixture thereof, and the like, but are not limited thereto. From the viewpoint of stability, preferably used are aluminum oxide, titanium oxide, niobium oxide, tin oxide, zinc oxide, silicon oxide, indium oxide, zirconium oxide, tantalum oxide, lanthanum oxide, gadolinium oxide, hafnium oxide, erbium oxide, neodymium oxide, cerium oxide, dysprosium oxide, and an oxide mixture thereof and a hydroxide mixture thereof.

In a case where the fine particle diameter is large, the irradiated light scatters, with a result that fine particles, which are sufficiently smaller than the wavelength of the irradiated light, must be used. Besides, even in a case of a plastic member required to have a transparency like the transparency, which an optical lens has, there is a problem in that, if the particle diameter is large, the transmittance is lowered due to influence of light scattering. Accordingly, an average particle diameter of the fine particles to be used in this embodiment is 50 nm or less, preferably 20 nm or less. Although depending on a target plastic member, particle diameter distribution preferably be narrow.

In order to uniformly disperse the fine particles within the polymerizable composition, it is preferred to subject the surface of the fine particles to chemical modification when forming the fine particles, or to subject the fine particles to dispersant addition treatment, or the like after the formation of the fine particles. The above-mentioned fine particles may be used alone, in mixture, or in complex. Further, like such a titanium oxide having an optical catalyst reaction, in order to prevent the resin from being decomposed by the reaction, there is a case of subjecting the surface to coating treatment, or the like with a silicon compound, etc. as needed.

The content of the fine particles differs depending on its target optical property or mechanical property, and further differs depending on the fine particles or the first monomer to be used and the kinds of the second monomer (d) component. However, the content of the fine particles with respect to the monomer (d) component is 1 mass % or more and 99 mass % or less, preferably 1 mass % or more and 70 mass % or less. Further, the fine particles to be dispersed are not limited to single kind, but multiple kinds of the fine particles may be dispersed.

It is preferred that each of the first radiation polymerizable composition (A) and the second radiation polymerizable composition (B) be in a liquid state.

Further, at the time of injection, or removal, each composition preferably be in a liquid state. If the compositions are in a solid state at room temperature or under atmospheric pressure, the injection or removal may be carried out under heating or pressurizing as needed.

The first radiation polymerizable composition (A) preferably be encapsulated within the casting cell having at least one transparent surface with respect to the radiation to be irradiated. An inner surface of the casting cell may be selected from a spherical surface, an aspherical surface, or a flat surface depending on a target device.

The casting cell can be produced through the provision of the spaces with spacers such as a gasket between two sheets of bases in which at least one of the bases is transparent with respect to the irradiation light. The casting cell is fixed with a spring clip as needed, and the radiation polymerizable composition (A) is injected into the spaces with a syringe, or the like. As the transparent material, there are exemplified known materials such as, for example, quartz, glass, transparent resins such as a silicon resin, fluororesin, an acrylic resin, a polycarbonate resin, or a polyimide resin, sapphire, diamond. In order to facilitate a step of removing the first radiation polymerizable composition (A) and the injection step for the second radiation polymerizable composition (B) to be described later, the radiation polymerizable composition (A) preferably be left while keeping a state in which syringe needle is pricked.

In order to facilitate mold-releasing of the first radiation polymerizable composition (A) and the second radiation polymerizable composition (B) after being cured, preferably the surface of the casting cell be treated with a mold release agent. The treatment with the mold release agent is carried out by applying the mold release agent, such as a fluororesin, a silicon resin, or a fatty acid ester by spraying, dipping, spin coating, or the like, and by heating as needed. Excess mold release agent may be removed by solvent washing or wiping off.

The radiation to be irradiated is selected depending on a sensitivity wavelength of the first radiation polymerizable composition (A) to be used, but it is preferred to use by appropriately selecting ultraviolet light having a wavelength about 200 to 400 nm, X rays, electron rays, or the like. As the first monomer (c) component, the ultraviolet light is particularly preferred, because various kinds of photosensitive compounds having sensitivity to the ultraviolet light are easily available. As a light source for emitting the ultraviolet light, there are exemplified, for example, a high pressure mercury lamp, an ultra-high pressure mercury lamp, a low-pressure mercury lamp, a Deep-UV lamp, a carbon arc lamp, a chemical lamp, a metal halide lamp, a xenon lamp, and the like, but the ultra-high pressure mercury lamp is particularly preferred. Those radiation may be used alone or in multiple.

By irradiating a part of the casting cell with radiation, a part of the first radiation polymerizable composition (A) is cured. As a method of irradiating the part thereof, the part of the casting cell may be covered with a shielding member, or the irradiation may be carried out by scanning a beam-like radiation.

Depending on the irradiation amount of radiation, the degree of polymerization of the first radiation polymerizable composition (A) can be controlled. At the radiation irradiation region, irradiation amount distribution may be provided.

For example, preferably the irradiation amount of the radiation to be irradiated onto the radiation irradiation surface of the casting cell be not constant, the irradiation amount of the radiation to be irradiated onto the radiation irradiation surface of the casting cell be small irradiation amount as approaching to the outer periphery thereof, or the irradiation amount of the radiation to be irradiated onto the radiation irradiation surface of the casting cell be high irradiation amount as approaching to the outer periphery thereof.

The diffusion rate is determined depending on the viscosity or cross-linking density, the diffusion behavior can be controlled by providing the irradiation amount distribution. In short, the refractive-index distribution profile can be controlled. As a method of providing the irradiation amount distribution, there are exemplified a method involving disposing on the cell a different gray scale mask having different radiation transmittances depending on places, a method involving moving the shielding member during the radiation irradiation, a method involving scanning a beam-like radiation, or the like, but is not limited thereto.

The degree of polymerization of the first radiation polymerizable composition (A) through the radiation polymerization is preferably the lowest polymerization degree, at the boundary surface of the irradiation portion and non-irradiation portion, to such an extent that, when an unpolymerized liquid-state first radiation polymerizable composition (A) is isolated using a syringe needle from the casting cell, the irradiation portion, namely, the cured portion is not collapsed. Further, in a removal step and an injection step for the second radiation polymerizable composition (B) to be described later, the lowest polymerization degree to such an extent that the shape thereof is not collapsed, is preferred.

Description is made of a curing degree of a polymer (polymer A) of the first radiation polymerizable composition (A) produced through the radiation irradiation.

The complex viscosity of the polymer A is preferably 10 Pa·sor more and 10000 Pa·s or less. If the complex viscosity is less than 10 Pa·s, when the uncured liquid-state first radiation polymerizable composition (A) is isolated from the casting cell using a syringe needle, the irradiation portion, namely, the cured portion is collapsed. If the complex viscosity is 10000 Pa·s or more in a stand still step described later, the progress of diffusion is delayed.

The complex viscosity can be measured using a dynamic viscoelasticity measuring device (for example, manufactured by Anton Paar Ltd., MCR-301).

In order to obtain a gel-like polymer to such an extent that the shape is not collapsed, the exposure amount at wavelength of 365 nm is 0.01 mJ/cm² or more and 1000000 mJ/cm² or less, preferably 0.1 mJ/cm² or more and 100000 mJ/cm² or less.

The uncured first radiation polymerizable composition (A) at the non-irradiation portion is removed from the casting cell. If the syringe needle used for the injection is left as it is, preferably the unpolymerized first radiation polymerizable composition (A) be sucked through the syringe needle. The removal may be carried out while heating or pressurizing as needed.

As the radiation polymerizable composition (A) contacting with the end surface of the gel is liquid state, the end surface of the gel is free from being damaged when being isolated.

The syringe containing the second radiation polymerizable composition (B) is attached to the syringe needle, and the liquid-state second radiation polymerizable composition (B) having different properties from the first radiation polymerizable composition (A) is charged into the spaces generated within the casting cell through the above-mentioned removal. The injection may be carried out while heating and pressurizing as needed.

After charging the second radiation polymerizable composition (B), the casting cell is left as it is for a predetermined time period. During the stand still step, between the polymerized radiation polymerizable composition (A) and the polymerizable composition (B), material exchange due to diffusion occurs, thereby being capable of obtaining composition distribution. As the polymerization degree is low as possible, the diffusion proceeds within a short period of time. For the purpose of accelerating the diffusion, during the stand still step, heating, electric field application, or magnetic field application may be performed, or the casting cell may be rotated. During the step of dispersing the second radiation polymerizable composition within the polymer of the first composition, the casting cell preferably be heated to a higher temperature than the room temperature (23° C.)

After the stand still step, in order to halt the material diffusion, radiation irradiation or/and heating are performed to cure the polymerized radiation polymerizable composition (A) and the polymerizable composition (B). For the radiation irradiation, the above-mentioned radiations may be used. The heating can be performed using known apparatus such as an oven or a hot plate. In order to obtain mechanical property and environmental stability, preferably be cured sufficiently.

It is preferred that the cured products of the first radiation polymerizable composition and the second radiation polymerizable composition each have different refractive index wavelength dispersion.

The cured product was taken out of the casting cell, to thereby obtain a plastic member having composition distribution, which being a target product.

### Second Embodiment

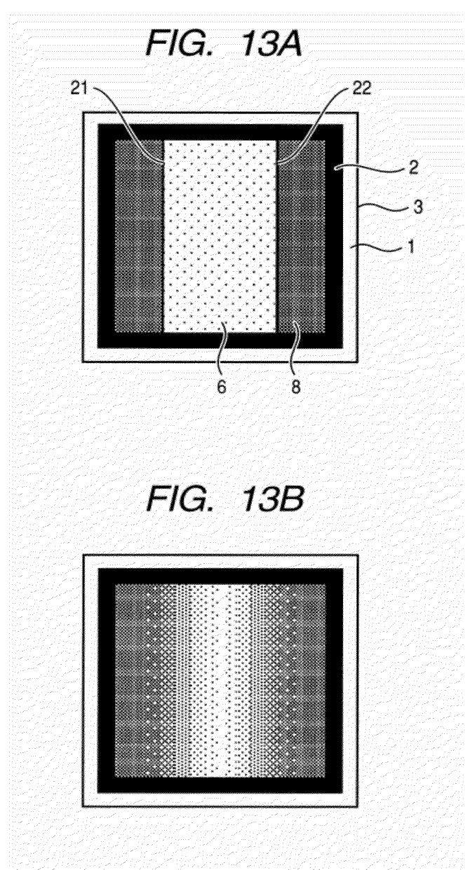

Referring to FIGS. 13A and 13B, description is made of a second embodiment of the present invention. FIGS. 13A and 13B are views viewed from top to bottom (or from bottom to top) direction of a paper surface with respect to FIGS. 1A to 1G.

It should be noted that, in this embodiment, the following description is made of differences from the first embodiment, and the description of items, which are common to the first embodiment, are omitted.

In a manufacturing method for a plastic member having composition distribution according to this embodiment, first, as described in the first embodiment, from the step of obtaining the polymer 6 of the first composition to the step of removing the unpolymerized first radiation polymerizable composition 4 from the casting cell are similarly carried out. However, the polymer 6 of the first composition is a cube or a rectangular shape.

Next, the second radiation polymerizable composition 8 containing the second monomer being radiation-polymerizable is brought into contact with an arbitrary surface (first surface 21) of the polymer 6 of the first composition, and with the back surface of the first surface (second surface 22) (FIG. 13A).

Then, after being left as it is for a predetermined period of time, the second radiation polymerizable composition 8 is dispersed within the polymer of the first composition 4 (FIG. 13B). After that, the entire of the second radiation polymerizable composition and the polymer of the first composition is cured through radiation irradiation or heating. As a result, there can be obtained a lens having composition distribution of the polymer of the first composition and the polymer of the second composition, from a first surface 21 toward a center portion, and from a second surface 22 toward the center portion. The obtained lens has the same function with a cylindrical lens.

Hereinafter, the invention is described in detail by way of specific examples.

### Example 1

A radiation polymerizable composition (A1) was prepared, including, as (d1) component, 90 parts by weight of benzyl(meth)acrylate (manufactured by KYOEISHA CHEMICAL Co., LTD.) and 10 parts by weight of trimethylolpropane triacrylate (manufactured by Sigma-Aldrich Japan), and as (c1) component, 0.1 parts by weight of an optical radical generator (Irgacure 184, manufactured by Chiba Japan Co., Ltd.).

A polymerizable composition (B2) was prepared, including, as (d2) component, 90 parts by weight of methyl methacrylate (manufactured by Sigma-Aldrich Japan) and 10 parts by weight of trimethylolpropane triacrylate (manufactured by Sigma-Aldrich Japan), and as (c2) component, 0.1 parts by weight of an optical radical generator (Irgacure 184, manufactured by Chiba Japan Co., Ltd.).

The refractive index of a cured product of benzyl (meth)acrylate is 1.568, the refractive index of a cured product of trimethylolpropane triacrylate is 1.509, and the refractive index of a cured product of methyl methacrylate is 1.490.

Onto two sheets of disc-like optical glass having a diameter of 70 mm and a thickness of 5 mm, dye-free aerosol type GA-6010 (manufactured by Daikin Industry Co.) was spray-coated as a mold release agent, and an excess mold release agent is wiped off with a cleaning cloth for optical equipment.

A Disc-like fluorine-based rubber-made O ring having a diameter of 35 mm and a thickness of 1.5 mm is sandwiched at the center portion of the two sheets of optical glass, and the two sheets of optical glass are fixed with spring clip at two opposing positions, to thereby form the casting cell. Using DispoSyringe, the radiation polymerizable composition (A1) is injected into the casting cell while taking an attention so that bubbles are not remain therein.

As the radiation irradiation light source, 250 W of UV light source EX250 provided with an ultra-high pressure mercury lamp (manufactured by HOYA CANDEO OPTRONICS CORPORATION) was used. As the shading product, an iris diaphragm having a minimum opening diameter of 2 mm and a maximum opening diameter of 50 mm (manufactured by Edmond Optics Japan, Co., Ltd.) was used. Between the light source and the shading product, an ultraviolet transmitting visible absorbing filter (UTVAF-50S-36U) and a frost type diffuser (DFSQ1-50C02-800) (both are manufactured by Sigma Corporation) are interposed. The intensity of illumination on the surface of the optical glass on the irradiation side of the casting cell was 10 mW/cm² at wavelength of 365 nm.

Irradiation was carried out with a diameter of an iris diaphragm opening of 20 mm for 300 seconds with respect to the center portion of the casting cell.

An empty DispoSyringe is attached to the syringe needle, an uncured radiation polymerizable composition (A1) was sucked. Next, the DispoSyringe into which the polymerizable composition (B1) was charged is attached to the syringe needle, the polymerizable composition (B1) was rapidly injected into the casting cell. The casting cell was left as it is for four hours at room temperature.

After the irradiation of the entire surface of the casting cell for one hour using the above-mentioned light source and optical system, the optical glasses were peeled off from each other, to thereby obtain a flat plate-like cured product.

A beam tracing type refractive-index distribution measuring apparatus (Index Profile Analyzer: IPA5-C, manufactured by Advanced Technology Co., Ltd.) was used to evaluate refractive-index distribution at a wavelength of 524.3 nm. The result thereof is shown in FIG. 2. Within a range of about 27 mm, successive refractive-index distribution reaching to about 0.056 was obtained.

### Example 2

A radiation polymerizable composition (A3) was prepared, including, as (d3) component, 75 parts by weight of benzyl(meth)acrylate (manufactured by KYOEISHA CHEMICAL Co., LTD.), as (e3) component, 25 parts by weight of zirconium oxide having an average diameter of 7 nm (manufactured by Osaka Sumitomo Cement Co. Ltd.), and as (c3) component, 0.1 parts by weight of an optical radical generator (Irgacure 184, manufactured by Chiba Japan Co., Ltd.).

A polymerizable composition (B4) was prepared, including, as (d4) component, 90 parts by weight of benzyl(meth)acrylate (manufactured by KYOEISHA CHEMICAL Co., LTD.) and 10 parts by weight of trimethylolpropane triacrylate (manufactured by Sigma-Aldrich Japan), and as (c4) component, 0.1 parts by weight of an optical radical generator (Irgacure 184, manufactured by Chiba Japan Co., Ltd.). The refractive index of zirconium oxide as (e3) component is 2.17.

In the same manner as in Example 1, the casting cell was prepared into which the radiation polymerizable composition (A3) was charged.

Irradiation was carried out with illumination intensity of 30 mW/cm² and with a diameter of iris diaphragm opening of 16 mm for 50 seconds with respect to the center portion of the casting cell by using the similar light source and optical system.

In the same manner as in Example 1, an uncured radiation polymerizable composition (A3) was sucked.

In the same manner as in Example 1, the polymerizable composition (B4) was rapidly injected into the casting cell.

### Example 2-1

The casting cell was left as it is for two hours at room temperature.

### Example 2-2

The casting cell was left as it is for two hours within the oven kept at a temperature of 80° C.

### Example 2-3

The casting cell was left as it is for 24 hours within the oven kept at a temperature of 80° C.

In the same manner as in Example 1, after irradiating the entire surfaces of the casting cells of Examples 2-1 to 2-3 with ultraviolet rays for one hour, the optical glasses were peeled off from each other, to thereby obtain flat plate-like cured products.

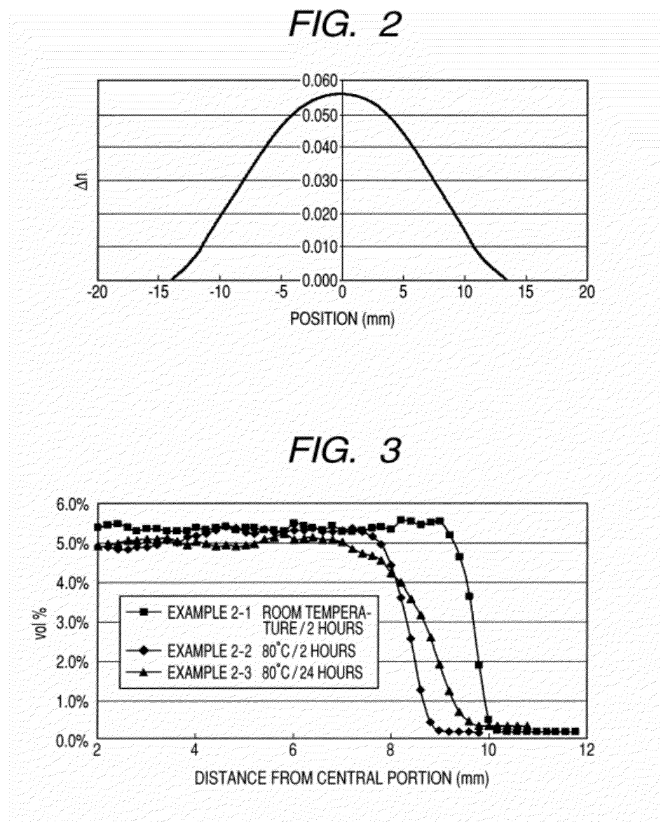

An energy-dispersing type minute portion fluorescent X rays analyzer, μEDX-1300 (manufactured by Shimadzu Corporation) capable of analyzing elements within 50 μmφ was used, and through mapping at 0.2 mm intervals a peak strength of fluorescent X rays derived from zirconium (15.85 keV), composition distribution of the surface on the irradiation side of the cured product was observed. The results thereof are shown in FIG. 3.

Zirconium oxide particles are eluted by diffusion from the cured products of the radiation polymerizable composition (A3), and there was obtained such a distribution in which the concentrations of the zirconium oxide particles within a range of from 1.6 mm to 3.6 mm at the boundary of the gel were successively changed from 0 vol % (0 wt %) to 5.0 vol % (25 wt %). Through heating to 80° C., behavior in which diffusion distance becomes longer was observed.

### Example 3

A radiation polymerizable composition (A5) was prepared, including, as (d5) component, 90 parts by weight of benzyl(meth)acrylate (manufactured by KYOEISHA CHEMICAL Co., LTD.) and 10 parts by weight of trimethylolpropane triacrylate (manufactured by Sigma-Aldrich Japan), and as (c5) component, 0.1 parts by weight of an optical radical generator (Irgacure 184, manufactured by Chiba Japan Co., Ltd.).

A polymerizable composition (B6) was prepared, including, as (d6) component, 90 parts by weight of benzyl(meth)acrylate (manufactured by KYOEISHA CHEMICAL Co., LTD.), as (c6) component, 0.1 parts by weight of an optical radical generator (Irgacure 184, manufactured by Chiba Japan Co., Ltd.), and as (e6) component, 10 parts by weight of zirconium oxide having an average diameter of 7 nm (manufactured by Osaka Sumitomo Cement Co. Ltd.).

In the same manner as in Example 1, the casting cell was prepared into which the radiation polymerizable composition (A5) was charged.

Irradiation was carried out with illumination intensity of 10 mW/cm² and with the diameter of iris diaphragm opening of 16 mm for 450 seconds with respect to the center portion of the casting cell by using the similar light source and optical system.

In the same manner as in Example 1, an uncured radiation polymerizable composition (A5) was sucked.

In the same manner as in Example 1, polymerizable composition (B6) was rapidly injected into the casting cell.

### Example 3-1

The casting cell was left as it is for four hours at room temperature.

### Example 3-2

The casting cell was left as it is for four hours within the oven kept at a temperature of 80° C.

In the same manner as in Example 1, after irradiating the entire surfaces of the casting cells of from Examples 3-1 and 3-2 with ultraviolet rays, the optical glasses were peeled, to thereby obtain flat plate-like cured products.

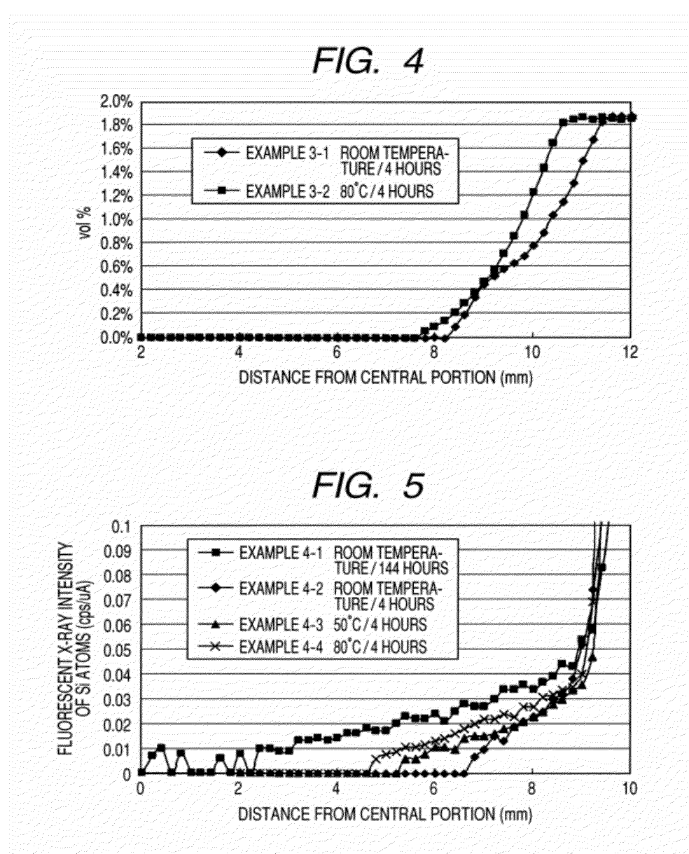

In the same manner as in Example 2, composition distribution of the surface of the cured product on the irradiation side was observed. The results thereof are shown in FIG. 4.

Zirconium oxide particles permeate by diffusion with respect to the cured product of the radiation polymerizable composition (A5), from the polymerizable composition (B6), and there was obtained such a distribution in which the concentrations of the zirconium oxide particles were successively changed from 0 vol % (0 wt %) to 1.9 vol % (10 wt %) within a range of 3.6 mm.

### Example 4

A radiation polymerizable composition (A7) was prepared, including, as (d7) component, 90 parts by weight of benzyl(meth)acrylate (manufactured by KYOEISHA CHEMICAL Co., LTD.) and 10 parts by weight of trimethylolpropane triacrylate (manufactured by Sigma-Aldrich Japan), and as (c7) component, 0.1 parts by weight of an optical radical generator (Irgacure 184, manufactured by Chiba Japan Co., Ltd.).

A polymerizable composition (B8) was prepared, including, as (d8) component, Highlink NanO G 130-31 (manufactured by Clariant Japan K.K., isobornyl acrylate dispersion of silica fine particles, silica content of 30 wt %) and 10 parts by weight of trimethylolpropane triacrylate (manufactured by Sigma-Aldrich Japan), and as (c8) component, 0.1 parts by weight of an optical radical generator (Irgacure 184, manufactured by Chiba Japan Co., Ltd.).

In the same manner as in Example 1, the casting cell was prepared into which the radiation polymerizable composition (A7) was charged.

Irradiation was carried out with illumination intensity of 10 mW/cm² and with the diameter of iris diaphragm opening of 16 mm for 45 seconds with respect to the center portion of the casting cell by using the similar light source and optical system.

In the same manner as in Example 1, an uncured radiation polymerizable composition (A7) was sucked.

In the same manner as in Example 1, the polymerizable composition (B8) was rapidly injected into the casting cell.

### Example 4-1

The casting cell was left as it is for 144 hours at room temperature.

### Example 4-2

The casting cell was left as it is for four hours at room temperature.

### Example 4-3

The casting cell was left as it is for four hours within the oven kept at a temperature of 50° C.

### Example 4-4

The casting cell was left as it is for four hours within the oven kept at a temperature of 80° C.

In the same manner as in Example 1, after irradiating the entire surfaces of the casting cells of from Examples 4-1 to 4-4 with ultraviolet rays, the optical glasses were peeled off from each other, to thereby obtain flat plate-like cured products.

In the same manner as in Example 2, distribution of fluorescent X-ray intensity derived from silicon oxide fine particles of the surface of the cured product on the irradiation side was observed. The results thereof are shown in FIG. 5. Silicon oxide particles are permeated from the composition (B) by diffusion with respect to the cured product of the composition (A), there was obtained such distribution in which fluorescent X ray intensity of the fluorescent X rays derived from silicon oxide particles were successively changed across a range of from 3.0 mm to 7.0 mm.

### Example 5

In the same manner as in Example 1, the casting cell was prepared into which the radiation polymerizable composition (A1) was charged.

A photomask having a diameter of 50 mm and having a disc-like transparent area having a diameter of 20 mm at its center portion was prepared.

A shading material of the photomask is chrome and a substrate is quartz. The transmittance of the shading is 0.01% or less at the wavelength of 365 nm, and the transmittance of the transparent portion is 98%.

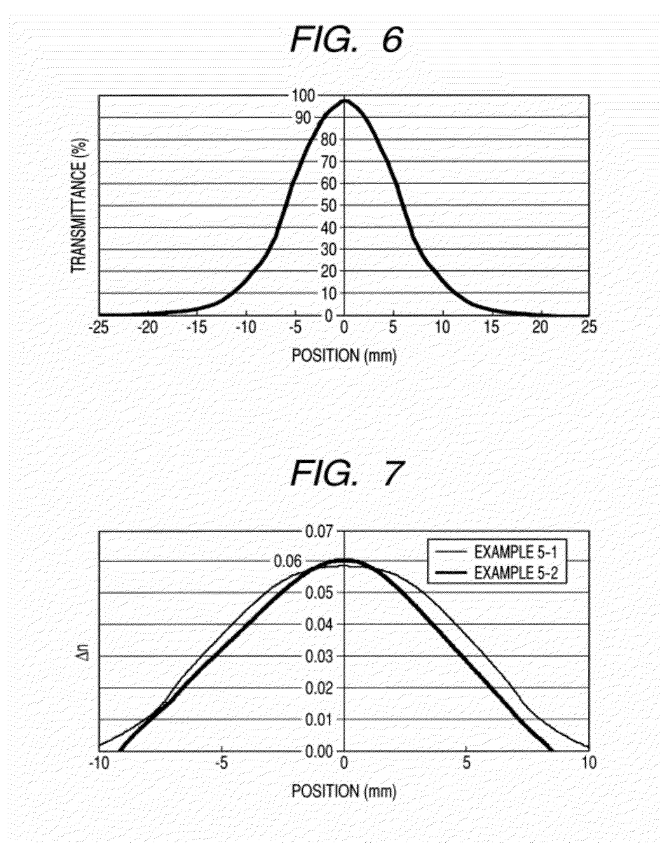

A gray scale mask was prepared having a transmittance profile as shown in FIG. 6. A shading material of the gray scale mask is inconel and a substrate is quartz.

### Example 5-1

The above-mentioned photomask was disposed at the center portion of the casting cell, and irradiation was carried out with illumination intensity of 30 mW/cm² for 300 seconds by using the similar light source and optical system.

### Example 5-2

The above-mentioned photomask and the above-mentioned gray scale mask were disposed in this order at the center portion of the casting cell, and irradiation was carried out with illumination intensity of 30 mW/cm² for 300 seconds by using the similar light source and optical system.

In the same manner as in Example 1, from the casting cells of Examples 5-1 and 5-2, an uncured radiation polymerizable composition (A1) was sucked.

In the same manner as in Example 1, the polymerizable composition (B2) was rapidly injected into the casting cells of Example 5-1 and 5-2.

In the same manner as in Example 1, the casting cells of Examples 5-1 and 5-2 were left as they are for four hours at room temperature.

In the same manner as in Example 1, after irradiating the entire surfaces of the casting cells of Examples 5-1 and 5-2 with ultraviolet rays, the optical glasses were peeled off from each other, to thereby obtain flat plate-like cured products.

In the same manner as in Example 1, evaluation was made of refractive-index distribution of the cured products of Examples 5-1 and 5-2 at a wavelength of 524.3 nm. The results thereof are shown in FIG. 7.

There was shown that different refractive-index distribution profiles were obtained through the use of gray scale mask.

### Example 6

In the same manner as in Example 2, the casting cell was prepared into which the radiation polymerizable composition (A3) was charged.

### Example 6-1

The same photomask as in Example 5 was disposed at the center portion of the casting cell, and irradiation was carried out with illumination intensity of 30 mW/cm² for 50 seconds by using the similar light source and optical system.

### Example 6-2

The same photomask as in Example 5 and the gray scale mask as in Example 5 were disposed in this order at the center portion of the casting cell, and irradiation was carried out with illumination intensity of 30 mW/cm² for 50 seconds by using the similar light source and optical system.

In the same manner as in Example 1, from the casting cells of Example 6-1 and 6-2, an uncured radiation polymerizable composition (A3) was sucked.

In the same manner as in Example 1, the polymerizable composition (B4) was rapidly injected into the casting cells of Example 6-1 and 6-2.

In the same manner as in Example 1, the casting cells of Examples 6-1 and 6-2 were left as they were at room for 144 hours.

In the same manner as in Example 1, after irradiating the entire surfaces of the casting cells of Examples 6-1 and 6-2 with ultraviolet rays for one hour, the optical glass were peeled, to thereby obtain flat plate-like cured products.

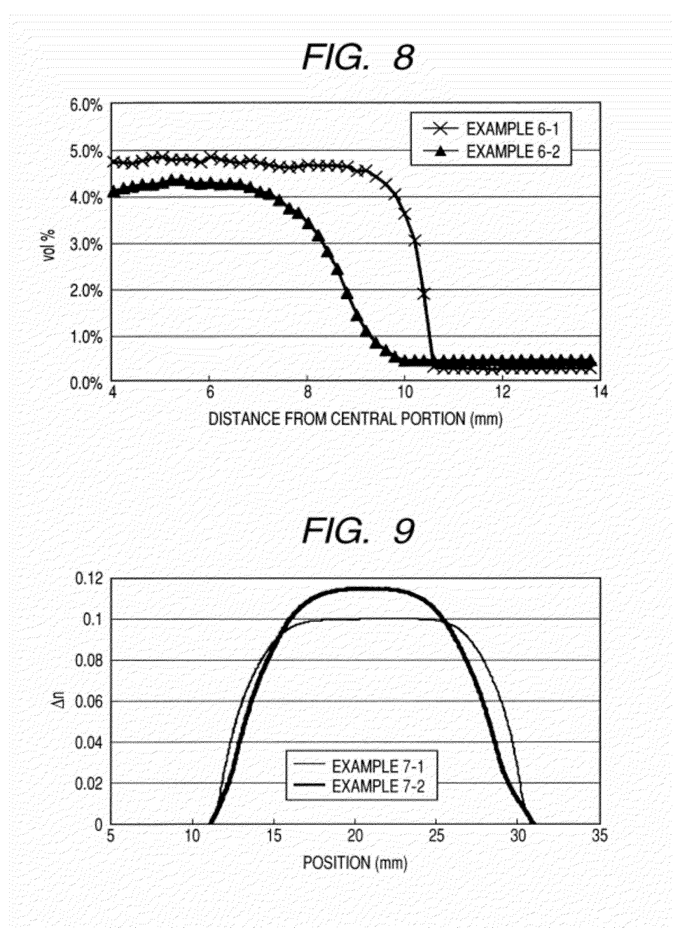

In the same manner as in Example 2, distribution of fluorescent X ray intensity of the fluorescent X rays (15.85 keV) derived from zirconium atom on the surface of the cured product on the irradiation side was observed. The results thereof are shown in FIG. 8.

In any of Example 6-1 and 6-2, zirconium oxide particles are eluted by diffusion from the cured products of the radiation polymerizable composition (A3), and there was obtained such a distribution in which the concentrations of the zirconium oxide particles at the boundary of the gel were successively changed from 0 vol % (0 wt %) to 5.0 vol % (25 wt %). Through the application of the gray scale mask, behavior in which diffusion distance becomes longer was observed, and also a different concentration distribution profile was obtained.

### Example 7

A polymerizable composition (B9) was prepared, including, as (d9) component, 72 parts by weight of tetrafluoro propyl methacrylate (manufactured by Osaka Organic Chemical Industry Ltd.), 18 parts by weight of methyl methacrylate (manufactured by Sigma-Aldrich Japan), and 10 parts by weight of trimethylolpropane triacrylate (manufactured by Sigma-Aldrich Japan), and as (c9) component, 0.1 parts by weight of an optical radical generator (Irgacure 184, manufactured by Chiba Japan Co., Ltd.).

In the same manner as in Example 1, the casting cell was prepared into which the radiation polymerizable composition (A1) was charged.

### Example 7-1

The same photomask used in Example 5 is disposed at a center portion of the casting cell, and irradiation was carried out with illumination intensity of 30 mW/cm² for 300 seconds by using the similar light source and optical system as in Example 1.

### Example 7-2

The same photomask used in Example 5 and the same gray scale mask used in Example 5 are disposed in this order at the center portion of the casting cell, irradiation was carried out with illumination intensity of 30 mW/cm² for 300 seconds by using the similar light source and optical system as in Example 1.

In the same manner as in Example 1, an uncured radiation polymerizable composition (A1) was sucked from the casting cells of from Examples 7-1 and 7-2.

In the same manner as in Example 1, the polymerizable composition (B9) was rapidly injected into the casting cells of from Examples 7-1 and 7-2.

In the same manner as in Example 1, the casting cells of from Examples 7-1 and 7-2 were left as they were for four hours at room temperature.

In the same manner as in Example 1, after irradiating the entire surfaces of the casting cells of Examples 7-1 and 7-2 with ultraviolet rays for one hour, the optical glasses were peeled, to thereby obtain flat plate-like cured products.

In the same manner as in Example 1, evaluation was made of refractive-index distribution of the cured products of Examples 7-1 and 7-2 at a wavelength of 524.3 nm. The results thereof are shown in FIG. 9.

There was shown that different refractive-index distribution profiles were obtained through the use of gray scale mask. In addition, through the use of gray scale mask, the larger difference in refractive indices was obtained.

As the reason of the large difference in refractive indices, there can be thought that the curing degrees of the end portions of the gel-like cured product of the radiation polymerizable composition (A1) are low, and the concentration of the gel end portions of the (B9) component becomes higher.

### Example 8

First, in the same manner as in Example 1, the casting cell was prepared into which the radiation polymerizable composition (A1) was charged. Then, as in Example 5, a photomask having a diameter of 50 mm and having a disc-like transparent area having a diameter of 20 mm at its center portion was prepared.

Next, exposure of ultraviolet rays was carried out with respect to the radiation polymerizable composition (A1) while changing an exposure time period as follows.

### Example 8-1

The above-mentioned photomask is disposed at the center portion of the casting cell, and exposure was carried out with illumination intensity of 30 mW/cm² for 150 seconds by using the similar light source and optical system.

### Example 8-2

The above-mentioned photomask is disposed at the center portion of the casting cell, and exposure was carried out with illumination intensity of 30 mW/cm² for 200 seconds by using the similar light source and optical system.

### Example 8-3

The above-mentioned photomask is disposed at the center portion of the casting cell, and exposure was carried out with illumination intensity of 30 mW/cm² for 300 seconds by using the similar light source and optical system.

### Example 8-4

The above-mentioned photomask is disposed at the center portion of the casting cell, and exposure was carried out with illumination intensity of 30 mW/cm² for 350 seconds by using the similar light source and optical system.

Next, in the same manner as in Example 1, from the casting cells of Example 8-1 to 8-4, an uncured radiation polymerizable composition (A1) was sucked. The gel within the casting cell of Example 8-1 was collapsed.

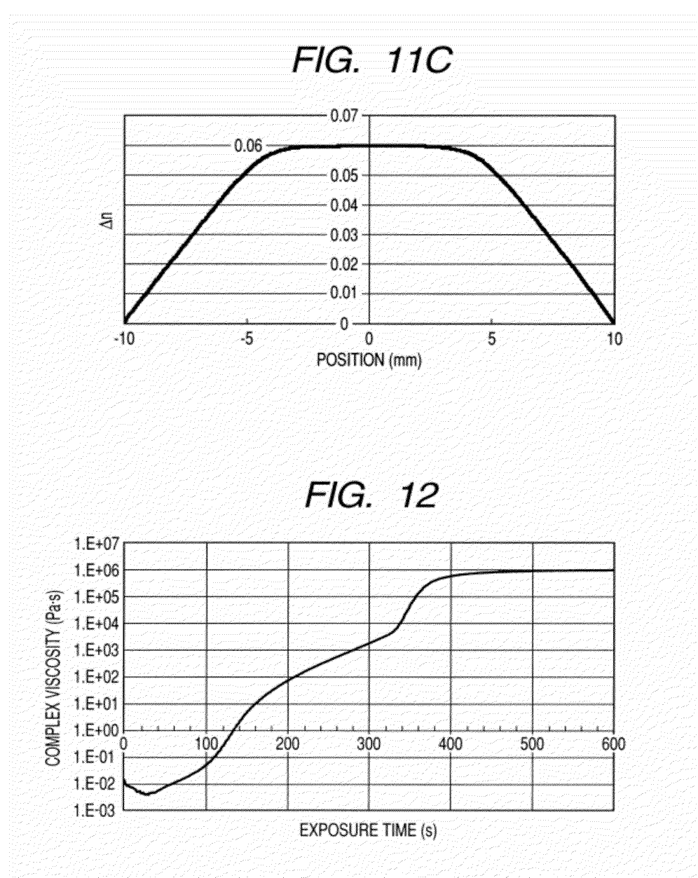

Further, in the same manner as in Example 1, the polymerizable composition (B2) was rapidly injected into the casting cells of from Example 8-2 to Example 8-4. In the same manner as in Example 1, the casting cells of Example 8-2 to Example 8-4 were left as they were for four hours at room temperature. In the same manner as in Example 1, after carrying out of exposure with ultraviolet rays for one hour on the entire surfaces of the casting cells of Example 8-2 to Example 8-4, the optical glasses were peeled off from each other, to thereby obtain flat plate-like cured products. In the same manner as in Example 1, evaluation was made of refractive-index distribution of the cured products of Examples 8-2 to 8-4 at a wavelength of 524.3 nm. The results thereof are shown in FIGS. 11A to 11C. As the exposure time period becomes longer, there was found such a tendency that refractive-index distribution profile of a center portion of the sample was flat. From this, there can be said that as the exposure time period is longer, the progress of the diffusion of the polymerizable composition (B2) into the gel is delayed.

### (Complex Viscosity)

Next, the relation between the exposure time period of the ultraviolet rays and the complex viscosity with respect to the radiation polymerizable composition (A1) was investigated using a dynamic viscoelasticity measuring device (manufactured by Anton Paar Ltd., MCR-301) provided with an ultraviolet irradiating mechanism. The illumination intensity of the ultraviolet rays was set to 30 mW/cm² at the wavelength of 365 nm. The relation between the exposure time period and the complex viscosity is shown in FIG. 12.

As a result, the complex viscosities were 4 Pa·s in Example 8-1, 697 Pa·s in Example 8-2, 1750 Pa·s in Example 8-3, and 39700 Pa·s in Example 8-4.

### (Conclusion)

It was found that the reason why the gel was collapsed in Example 8-1 resides in that the complex viscosity is too low. Then, it was found that the reason why the progress of diffusion was delayed as the exposure time period became longer in Example 8-2 to Example 8-4 resides in that the complex viscosity is high as the exposure time period is longer.

### Comparative Example 1

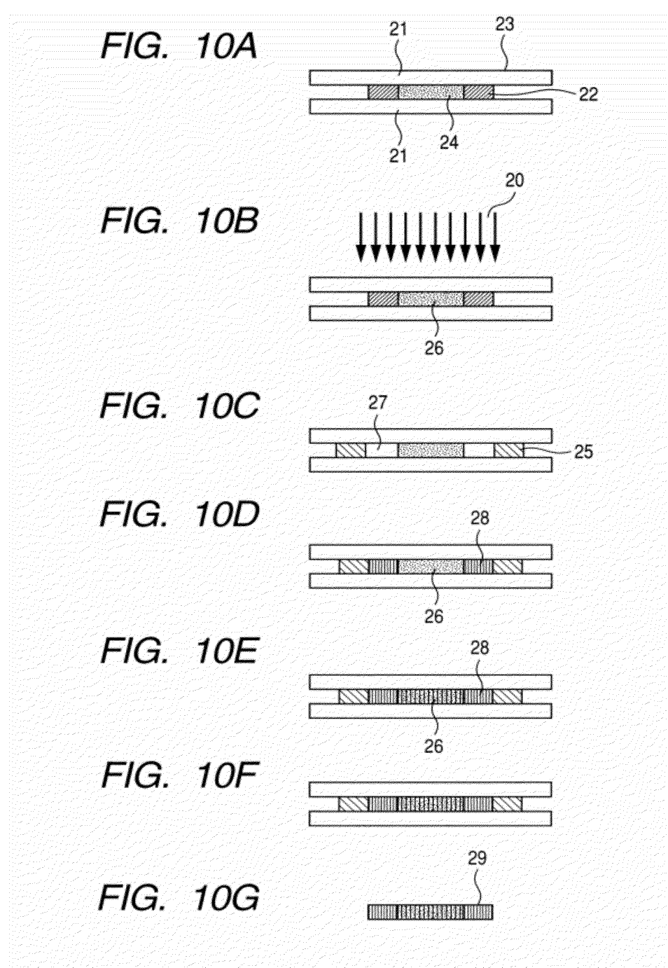

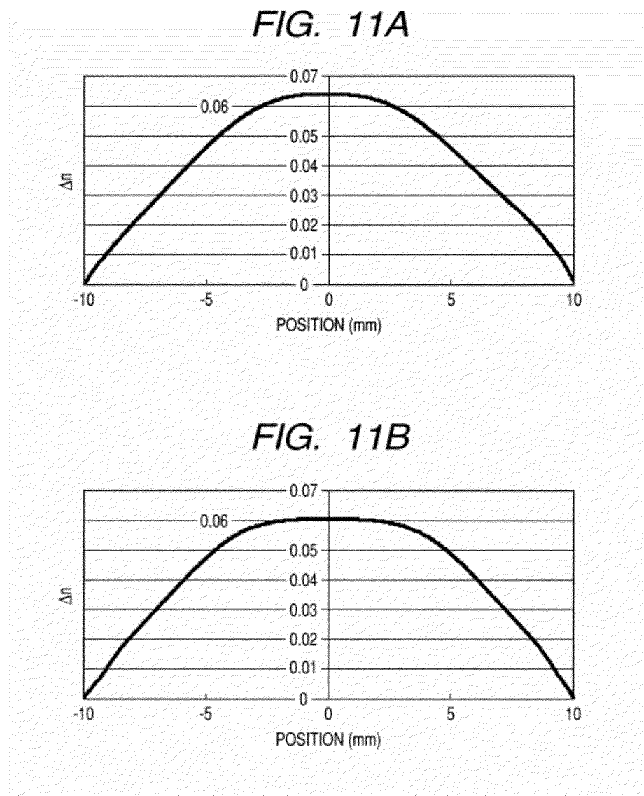

FIGS. 10A to 10G illustrate a manufacturing method for a plastic member according to Comparative Example 1 of the present invention.

The plastic member was manufactured using the same radiation polymerizable composition (A1) and polymerizable composition (B2) used in Example 1.

Between two sheets of optical glass 21, which are similar to ones used in Example 1, spacers 22 are sandwiched, to thereby construct a casting cell 23. Using DispoSyringe, the radiation polymerizable composition (A1) was injected into the casting cell.

In the same method as in Example 1, irradiation of radiation was carried out under the conditions of 10 mW/cm² for 300 seconds with respect to the entire region of the radiation polymerizable composition (A1), to thereby obtain a gel-like polymer 26 of the polymerizable composition (A1).

The spacers 22 within the casting cell 23 were subjected to removal, the polymer 26 was collapsed.

### Comparative Example 2

FIGS. 10A to 10G illustrate a manufacturing method for a plastic member according to Comparative Example 2 of the present invention.

The plastic member was manufactured using the same radiation polymerizable composition (A1) and polymerizable composition (B2) used in Example 1.

Between two sheets of optical glass 21, which are similar to ones used in Example 1, spacers 22 are sandwiched, to thereby construct a casting cell 23. Using DispoSyringe, the radiation polymerizable composition (A1) was injected into the casting cell.

In the same method as in Example 1, irradiation of radiation was carried out under the conditions of 10 mW/cm² for 1800 seconds with respect to the entire region of the radiation polymerizable composition (A1), to thereby obtain a gel-like polymer 26 of the polymerizable composition (A1).

The spacers 22 within the casting cell 23 were removed, and spaces 27 were formed outside the polymer 26 of polymerizable composition (A1). Spacers 25 were disposed therein to fabricate the casting cell 23.

Next, a polymerizable composition (B1) 28 was injected into the spaces 27 of the casting cell 23 by using a syringe needle to be in contact with the gel-like polymer 26 of the polymerizable composition (A1). The casting cell was left as it is for four hours at room temperature. After irradiating the entire surface of the casting cell with radiation, the optical glasses were peeled off from each other, to thereby obtain a plastic member 29 formed of a flat plate-like cured product.

The refractive-index distribution of the obtained plastic member was measured in the same method as in Example 1, significant refractive-index distribution was not generated in the area of the polymer 26.

### INDUSTRIAL APPLICABILITY

According to the present invention, the plastic member having composition distribution can be obtained with simple facility and a small number of steps for a short period of time. Consequently, the present invention can be applied to a manufacturing method for a lens of an image formation system of a camera or an optical fiber, a pickup optical system of a copying machine or a compact disk, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-202936, filed on Sep. 2, 2009, which is hereby incorporated by reference herein in its entirety.

1. A manufacturing method for a plastic member having composition distribution, comprising the steps of:
charging a first radiation polymerizable composition containing a first monomer being radiation-polymerizable into a casting cell having formed thereon a radiation irradiation surface;
obtaining a polymer of a first composition by irradiating the radiation irradiation surface of the casting cell with the radiation, to thereby polymerize a part of the first radiation polymerizable composition;
removing an unpolymerized part of the first radiation polymerizable composition from the casting cell;
bringing into contact with the polymer of the first composition by charging a second radiation polymerizable composition containing a second monomer being radiation-polymerizable into gaps of the casting cell, which are generated by the removal;
dispersing the second radiation polymerizable composition into the polymer of the first composition; and
curing an entire of the second radiation polymerizable composition and the polymer of the first composition dispersed within the casting cell.

2. A manufacturing method for a plastic member according to claim 1, wherein the first radiation polymerizable composition and the second radiation polymerizable composition are in a liquid state.

3. A manufacturing method for a plastic member according to claim 1, wherein the polymer of the first composition obtained by polymerizing the first radiation polymerizable composition is in a gel state.

4. A manufacturing method for a plastic member according to claim 1, wherein at least one of the first radiation polymerizable composition and the second radiation polymerizable composition contains fine particles.

5. A manufacturing method for a plastic member according to claim 1, wherein each of cured products of the first radiation polymerizable composition and the second radiation polymerizable composition has different refractive index wavelength dispersions.

6. A manufacturing method for a plastic member according to claim 1, wherein an amount of the radiation to be irradiated onto the radiation irradiation surface of the casting cell is not constant (fluctuates).

7. A manufacturing method for a plastic member according to claim 6, wherein the amount of the radiation to be irradiated onto the radiation irradiation surface of the casting cell is a lower irradiation amount as approaching to an outer periphery.

8. A manufacturing method for a plastic member according to claim 6, wherein the amount of the radiation to be irradiated onto the radiation irradiation surface of the casting cell is a higher irradiation amount as approaching to an outer periphery.

9. A manufacturing method for a plastic member according to claim 1, wherein in the step of dispersing the second radiation polymerizable composition into the polymer of the first composition, the casting cell is heated to higher temperature than room temperature.

10. A manufacturing method for a plastic member according to claim 1, wherein an inner surface of the casting cell comprises at least one of a sphere surface, an aspherical surface, and a flat surface

11. A plastic member, which is manufactured by the manufacturing method for a plastic member according to claim 1.

12. A manufacturing method for a plastic member according to claim 1, wherein a complex viscosity of the polymer of the first composition is 10 Pa·s or more and 10000 Pa·s or less.
